(19) United States
(12) Patent Application Publication
(10) Pub. No.: US 2014/0217741 A1
(43) Pub. Date: Aug. 7, 2014

(54) SYSTEM FOR TWISTING CABLES IN A WIND TURBINE TOWER

(71) Applicant: ENVISION ENERGY (DENMARK) APS, Silkeborg (DK)

(72) Inventor: Mogens CHRISTENSEN, Tjele (DK)

(73) Assignee: ENVISION ENERGY (DENMARK) APS, Silkeborg (DK)

(21) Appl. No.: 14/092,148

(22) Filed: Nov. 27, 2013

(30) Foreign Application Priority Data
Dec. 6, 2012 (DK) PA 2012 70766

(51) Int. Cl. F03D 11/00

(52) U.S. Cl. CPC F03D 11/0066
USPC 290/55

(57) ABSTRACT

The invention relates to a wind turbine having a wind turbine tower and a nacelle provided on top of the tower to which a rotor hub with one or more wind turbine blades is rotatably mounted. A cable twisting system is arranged inside the tower and suspended from the bottom of the nacelle. The cable twisting system comprises cable spacing plates coupled to a suspension element. Guiding means guide the electrical cables from the nacelle to the bottom of the tower. The suspension element is a torsion element having a first end capable of twisting relative to a second end when torque is applied to the first end therefore allowing individual cable spacing plates to be rotated in a more uniform manner when the nacelle is yawing. This also allows upwards movement of the cable spacing plates caused by the applied torque to start at the uppermost cable spacing plate.

### CROSS-REFERENCE TO RELATED APPLICATIONS

This application claims the benefit of Danish Patent Application No. PA 2012/70766 filed Dec. 6, 2012, the entire disclosure of which is incorporated herein by reference.

### FIELD OF THE INVENTION

The present invention relates to a wind turbine comprising:

a wind turbine comprising:

a wind turbine tower having an inner side, a bottom, and a top

a nacelle provided on top of the wind turbine tower, wherein the nacelle is arranged on one or more yaw bearings configured to rotate the nacelle relative to the wind turbine tower

a rotor hub rotatable mounted to the nacelle, where one or more wind turbine blades are mounted to the rotor hub

a cable twisting system configured to be arranged inside the wind turbine tower, where the cable twisting system comprises one or more cable spacing plates coupled to at least one suspension element, wherein the cable spacing plates are distributed along a length of the cable twisting system and comprise one or more guiding means configured to guide one or more electrical cables from the top in a direction towards the bottom of the wind turbine tower, where the electrical cables are connected to the nacelle and extend into the inside of the wind turbine tower through the top.

### BACKGROUND OF THE INVENTION

It is well known to transmit the power generated in a nacelle, which is located at the top of a wind turbine tower, to electrical cables located at the bottom of the wind turbine using another set of electrical cables extending along the inside of the tower. The cables located inside the tower are typically connected to a generator, a converter, or other electrical equipment in the nacelle, and the cables at the bottom of the tower are typically connected to cables extending underground or along the seabed to e.g. a sub-station or another station.

In order to allow the nacelle to make yaw movements relative to the tower of the wind turbine, these cables are arranged in the center of the tower, so that pulling in the cable is minimized and twisting becomes the most important issue. The cables typically hang free from the tower and are often guided downwards along a number of rings/frames and/or a so-called cable stocking so that the cables are only guided into a forced rotation. The guiding structure is often a fixture installed on or around the cable and is fitted with a recess or hole in which the cable can be hanging. As the nacelle is yawing, the free hanging cables will twist over a certain length causing the lower part of the cables to be lifted as the cables tend to take a helical shape during the twist. In order to compensate for this, it is common to form a so-called cable loop at the bottom of the free hanging cables.

When the cables are being twisted, they will tend to hold the lowest level of potential energy, which means that the heaviest part (the upper part) of the cables will twist less than the lightest part (the lower part) of the cables. A high rate or portion of twist over a short length may lead to rubbing between the cables and the guided structure. This may also lead to clogging of the cables resulting in a change of the thermal cooling conditions, thereby increasing the cable temperature to an unacceptable level.

Wind turbines today typically comprise a module or function which senses the yaw of the nacelle or the cable twist. When the module or function senses that the cable or nacelle has reached its maximum twist threshold, then the wind turbine stops and rotates the cable or nacelle back into its initial position, e.g. zero degrees, thereby untwisting the cables. The guiding structures are typically designed to operate with a maximum twist of ±720-1080 degrees; some may even have a maximum of ±1800 degrees.

From US 2010/0247326 A1 a solution as described above is known. A number of cables are hanging from the main structure at the nacelle, where the cables are situated in the center of the tower. The cables are guided through a plurality of holes in a number of circular shaped plates in which the cables are arranged in bundles along the outer periphery of the plates. The plates are held in their respective positions on a suspension wire or rope using clamping fasteners where the suspension wire/rope is attached to the nacelle. The lowermost plate is attached to the inner sidewall of the wind turbine tower using fixtures, so that the plate does not rotate relative to the tower when the cables are twisted. The other plates are rotated relative to the suspension element due to the twisting of the cables. As the cables are held in place by the holes in the plates, there will be a bend in the cables below and above the plate when the cables are twisted, which over time will destroy the cable and the cable has to be replaced, with down time and high costs as a consequence.

Since the lowermost plate is prevented from rotating, the cables will be sliding in and out of the holes in that plate which quickly will wear out the insulation around the conducting material on the cables. This problem is to some extend addressed by preparing the plates with holes having edges which are rounded off, but as the individual cables are twisted they will be forced towards these edges, and they will wear and fail such that a short circuit might appear. A further disadvantage is that the cables have to be installed from the bottom up or from the top down by guiding each and every cable through a number of holes in the plates. This is a troublesome and time-consuming process and thus also expensive.

Another problem with the solution disclosed in US 2010/0247326 A1 is getting rid of heat emitted from the cables because they are arranged in small bundles relatively close to each other on a relative small plate. The reason for having a small diameter of the plates is believed to be an attempt to minimize the distance between the cables having to travel up and down during twisting. A small diameter demands less travel of the cables and vice versa, but it will increase the deformation of the cables and also stresses the cables. Furthermore, since the bundles of cables will be more compact using a small plate, less heat will be moved away by natural convection.

CN 202004388 U discloses a circular cable spacer for a wind turbine having a number of fingers extending in a radial direction outwards from a center part of the spacer. The fingers form a number of gaps configured for receiving the cables. The length of the fingers is less that the diameter of the cables so a clamping band is used to press and hold the cables in position in the gaps. When the cables are twisted, they will take a shape similar to that of the hour glass, thus bringing the cables into contact with the edges of contacting surfaces. This configuration has the drawback that the contacting surfaces form a number of sharp edges which will damage the insulation of the cables and eventually causing the cables to fail. Furthermore, since the cables are held in place by the clamping band, there will be a bending of the cables at both sides of the cables spacer; this will also damage the cable over time.

CN 201568227 U discloses a similar cable spacer comprising fingers for holding the cables in position. This solution also suffers from the drawbacks of wear and bending as discussed above. This solution has to be installed piece by piece in order to arrange the cables between the fingers. Furthermore, the fingers on the outermost periphery have a depth which is less than the diameter of the cables and are not held in place; thus there is a high risk that one of the cables will glide out of its position between the fingers.

### OBJECT OF THE INVENTION

An object of the invention is to provide a cable twisting system which rotates the individual plates in a uniform manner

An object of the invention is to provide a cable twisting system where the rotation is started at the uppermost plate.

An object of the invention is to provide a cable twisting system with a reduced friction between the cables and the guiding means.

An object of the invention is to provide a cable twisting system capable of differentiating the torque generated along the length of the system.

### DESCRIPTION OF THE INVENTION

An object of the invention is achieved by a wind turbine, characterized in that

the suspension element is a torsion element comprising a first end facing the nacelle and a second end facing the bottom of the wind turbine tower which both have a common center axis, wherein the first end is configured to twist relative to the second end due to its torsion properties when torque is applied to the first end, and wherein the first end is configured to return to its initial position when the torque is removed.

This provides a cable twisting system capable of rotating the individual cable spacing plates in a more uniform manner when the nacelle is yawing. The configuration allows the upwards movement of the cable spacing plates, which is caused by the torque applied by the nacelle, to start at the uppermost cable spacing plate, unlike a traditional cable twisting system where the upwards movement starts at the lowermost cable spacing plate. The angular rotation of the cable spacing plates allows an improved twist of the cables along the length of the cable twisting system, so that the risk of rubbing between the cables and the guiding means is reduced. This also reduces the risk of clogging the cables, thus allowing the temperature of the cable to be maintained at an acceptable level. The angular rotation of the cable spacing plates relative to each other may be determined by the torsion properties of the suspension element, the maximum allowable twist, and the number of cable spacing plates arranged along the length of the cable twisting system.

The suspension element may be made of metal, such as iron (e.g. wrought iron), steel (e.g. mild steel), titanium or copper, glass/organic fiber reinforced plastic/composite or another suitable material or composite. The suspension element may be made of an alloy, such as metal alloy (e.g. steel or carbon alloy). The suspension element may have a circular or squared cross-section and/or a thickness between 5-50 mm. The cable spacing plates may be made of metal, e.g. iron or steel, plastics, e.g. polycarbonate, polyester or polymer, glass/organic fiber reinforced plastics/composite or another suitable material. If the cable spacing plates are made of metal, they may be at least partly covered with a protective and/or friction reducing plastic, coating or skin.

According to one embodiment, the cable spacing plates divide the cable twisting system into two or more sections, where the suspension element extends through at least one of the cable spacing plates which is coupled to the suspension element.

The suspension element may be formed as a torsion rod or spring to which one or more cable spacing plate may be attached using fastening means in the form of bolts, pins, screws, or the like. A bushing in the form of a sleeve or flange may be used to hold the cable spacing plate at its position on the torsion rod or spring. The torsion rod may be solid or hollow, e.g. tubular. The cable twisting system may comprise a single suspension element having a length corresponding to the entire length of the cable twisting system where each cable spacing plate is attached to the suspension element as mentioned above. This allows the angular rotation of the cable spacing plates to follow the torsion/twist of the rod or spring. This also allows the torsion rod or spring to have the same torsion properties along the length of the rod or spring. A number of parallel torsion rods, e.g. two, three, four, five or more, may form the suspension element where each torsion rods is firmly attached to each cable spacing plate. Alternatively at least one of the torsion rods may comprise one or more slots or tracks which either extend through the thickness of the rod or have a depth which is less than the thickness of the rod. The number of sections and the distance between each cable spacing plate forming the sections may be determined by the maximum allowable twist.

The cable twist system may have a length between 5-20 m, preferably between 10-15 m and/or comprise 5-20 sections distributed along the length of it. The cable twist system may be configured to operate at a maximum allowable twist between 1360-1800 degrees, preferably between 1720-1080 degrees. Each cable spacing plate may be configured to have an angle of rotation between 130-210 degrees relative to an adjacent cable spacing plate at the maximum twist.

According to one embodiment, the cable spacing plates divide the cable twisting system into two or more sections, wherein at least one of the sections comprises another separate suspension element which is coupled to at least one cable spacing element.

This allows each suspension element to be attached to mounting means arranged on a side surface of the cable spacing plate using fastening means in the form of bolts, pins, screws, or the like. This allows a quick and easy assembly of the cable twisting system where the length of the cable twisting system may be adjusted by simply adding or removing a cable spacing plate and a suspension element. The use of individual suspension elements in two or more sections allows the suspension elements to have different torsion properties which enable the cable twisting system to compensate for large twisting moments generated in the lower sections. This allows the rotational angle and/or the distance between the cable spacing plates to be the same or to differ along the length of the cable twisting system, thus allowing at least one section to have a greater or smaller length than the length of another section.

The torsion rod or spring forming the single suspension element, as mentioned earlier, or each of individual suspension elements may have a Young's modulus of at least 30 GPa, preferably 100 GPa or higher, preferably 200 GPa or higher. This allows the suspension element to have sufficient strength and enable the rotation of the cable spacing plates to remain within an acceptable level, so that cables are not subjected to a large bending load which would cause the cables to fail.

According to a particular embodiment, the second end of the suspension element in the lowermost section relative to the nacelle is configured to be mounted to a support unit arranged inside the wind turbine tower.

This allows all of the cable spacing plate to be rotated relative to the nacelle during yawing, which increases the length in which the twist occurs. This allows the cables extending downwards from the lowermost cable spacing plate to follow the rotation of that plate and/or the upwards movement of the cables without having to move up or down relative to a stationary plate. This also reduces the wear on the insulation of the conductive material of the cables which would occur if the lowermost plate was stationary.

According to one embodiment, the guiding means are protrusions formed on the cable spacing plate and extend in a radial direction outwards from the plate's center axis, where a number of recesses are formed between the protrusions which are configured to receive at least one of the cables.

The cables may hang loosely or uncoupled in the recesses or punches formed between the protrusions, since each recess/punch may have a depth which more or less corresponds to the thickness of the cables located in that recess/punch. This minimizes the stresses in the cables due to the twist which normally occurs when the cables are held in their respective positions by a clamping band or a ring as the nacelle yaws. The recess/punch may define an open space in which the cables hang loosely where the open space may be closed off by a clamping band arranged along the free ends of the protrusions. The protrusions and the size of the plate allow the cables to be separated or arranged in small bundles with a certain distance between each cable or bundle; thus keeping the cables at an acceptable temperature even when the wind turbine is producing energy at its maximum at high ambient temperatures.

The cable spacing plates may be formed as a disc or ring having a circular or polygonal shape. The shape of the cable spacing plate defines an outer periphery with an outscribed circle having a diameter of 30 mm or more, preferably between 40-1500 mm. The protrusion may have a length of 30-200 mm, preferably 50-150 mm and/or three or more protrusions, preferably between five and fifteen, and may be arranged at or near the outer periphery of the cable spacing plate.

According to a particular embodiment, each protrusion comprises a first side surface and a second side surface, where the first side surface faces another second side surface on an adjacent protrusion and the second side surface faces another first side surface on an adjacent protrusion, wherein at least one of the two side surfaces is convex.

The sides of protrusions may have a biconvex or curved shape or be formed as impeller blades. The bottom of the recesses may also have a convex or curved shape. By using a convex side surface, the contact area between a cable and the protrusion is maximized which in turn prevent wear of the insulation jacket of the cable. This also allows the cables when twisted to lean less against the side surface (and the edges thereof), since the cables are supported by a larger surface. This is particular relevant when the cable spacing plate has a circular or polygonal shape, since the twisted cable will be pressed against the convex surface and/or bottom. The convex surface also prevents the cables from being bent with a radius smaller than that of the convex surface which in turn prevents the cables from being damaged due to sharp bends.

The curvature of the protrusions and/or the bottom of the recess may curve towards an opposite protrusion and/or away from the plate where the curve may have a radius of 10 mm or more, preferably 20 mm or more.

According to another particular embodiment, the guiding means are wheels configured to rotate around a second center axis which is connected to the cable spacing plate and arranged relative to the plate's center axis, wherein the wheels comprise at least one surface configured to receive and guide at least one of the cables.

This allows the frictions of the guiding means to be reduced since the wheel is able to rotate along the cable when the cable is twisted. The wheels may be arranged along the outer periphery and/or an inner periphery of the cable spacing plate, which in this embodiment may have ring shaped configuration which is attached to the suspension element. The wheels may be made of nylon, rubber, thermoplastic, e.g. polyoxymethylene (POM), or another suitable material. The wheel may also be made of metal which may be coated or covered with a low friction material or skin. The wheels may be arranged relative to the plane of the cable spacing plate, e.g. perpendicularly, so that their center axis is located in the same plane as the cable spacing plate, e.g. extending in a radial direction outwards from the plate's center axis and/or in a lateral direction relative to the plate's center axis. Two or more wheels may be arranged relative to at least one of the cables or bundle of cables. Rollers may be used instead of the wheels.

According to one embodiment, the cable twisting system comprises a support unit arranged inside the wind turbine tower, wherein one end of the support unit is configured to be mounted to the inner side of the wind turbine tower and the other end is configured to be mounted to the suspension element in the lowermost section relative to the nacelle.

The support structure stabilizes the cable twisting system relative to the wind turbine tower and allows the suspension element to be aligned with the center axis of the nacelle. The support structure keeps the lowermost end of the suspension element stationary which allows the remaining part of the suspension element to twist relative the uppermost end.

The lowermost end of the suspension element may be located at least 8 m, preferably 10 m or more, from the bottom of the nacelle which lays against the yaw bearings. The wind turbine tower may have an outer height of at least 75 m, preferably at least 80 m where the bottom of the nacelle is located more or less in the same height.

According to one embodiment, a second guiding unit is arranged inside the wind turbine tower between the cable twisting system and the bottom of the wind turbine tower, wherein the second guiding unit is configured to guide the cables to the bottom of the wind turbine tower.

This allows the cables to be held in place along the remaining length of the wind turbine tower, so that the cables do not start to swap due to vibrations in the wind turbine and/or displacement of the upper part of the wind turbine tower.

According to a particular embodiment, the cables form a cable loop arrangement between the cable twisting system and the second guiding unit.

The second guiding unit also enables the cables to form a cable loop arrangement just below the cable twisting system in order to compensate for the retraction occurring when the cables are twisted. The excess amount of cable forming the cable loop arrangement may have a cable length, e.g. 1 m or more, preferably 2 m or more, which at least corresponds to the maximum lift or displacement of the cables relative the lowermost cable spacing plate.

According to one embodiment, a third guiding unit is configured to be arranged between the nacelle and the cable twisting system, wherein the third guiding unit is configured to be mounted to the nacelle and comprises one or more guiding means for guiding the cables from the nacelle to the cable twisting system.

This allows the cables to be guided safely through the top of the wind turbine tower and into the cable twisting system. This prevents the cables from hitting or rubbing against the peripheral edges of the opening formed in the top during yawing of the nacelle, which could damage the isolation of the cables and cause a failure.

### DESCRIPTION OF THE DRAWING

The invention is described by example only and with reference to the drawings, wherein:

FIG. 1 shows an exemplary embodiment of a wind turbine;

FIG. 2 shows a first exemplary embodiment of a cable twisting system arranged inside a wind turbine tower;

FIG. 3 shows a second exemplary embodiment of the suspension element;

FIG. 4 shows an upper portion of a second exemplary embodiment of a cable twisting system;

FIG. 5 shows a lower portion of the second cable twisting system shown in FIG. 4;

FIG. 6 shows an exemplary embodiment of a cable loop arrangement connected to the cable twisting system shown FIG. 5; and

FIG. 7 shows the second cable twisting system shown in FIGS. 4 and 5 with an exemplary embodiment of a top section.

In the following text, the figures will be described one by one and the different parts and positions seen in the figures will be numbered with the same numbers in the different figures. Not all parts and positions indicated in a specific figure will necessarily be discussed together with that figure.

### DETAILED DESCRIPTION OF THE INVENTION

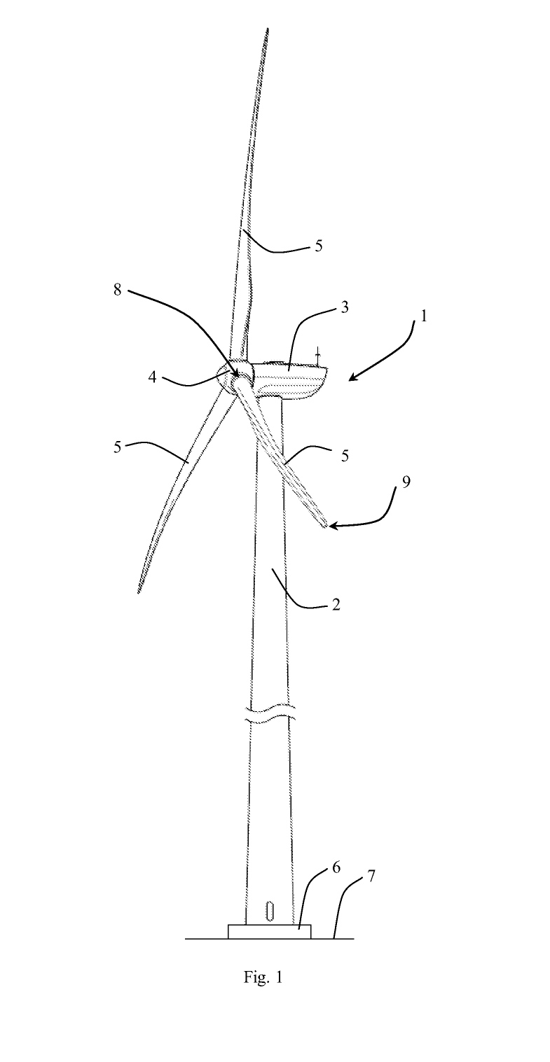

FIG. 1 shows an exemplary embodiment of a wind turbine 1 comprising a wind turbine tower 2 and a nacelle 3 mounted at top of the wind turbine tower 2. The wind turbine tower 2 may comprise one or more tower sections mounted on top of each other. A rotor hub 4 may be rotatable mounted to the nacelle 3 via a rotor shaft. One or more wind turbine blades 5 may be mounted to the rotor hub 4 via a shaft extending outwards from the center of the rotor hub. Two or three wind turbine blades 5 may be mounted to the rotor hub 4 where the wind turbine blades 5 form a rotation plane. The wind turbine tower 2 may be mounted onto a foundation 6 extending above a ground level 7.

The wind turbine blade 5 may comprise a blade root 8 configured to be mounted to the rotor hub 4. The wind turbine blade 5 may comprise a tip end 9 arranged at the free end of the blade 5. The wind turbine blade 5 has an aerodynamic profile along the length of the blade. The wind turbine blade 5 may be made of fiber reinforced plastics or composites, e.g. having fibers made of glass, carbon, or organic fibers, which form a laminate. The laminate may be infused using a resin, e.g. epoxy, supplied by an external system, e.g. a vacuum infusion system.

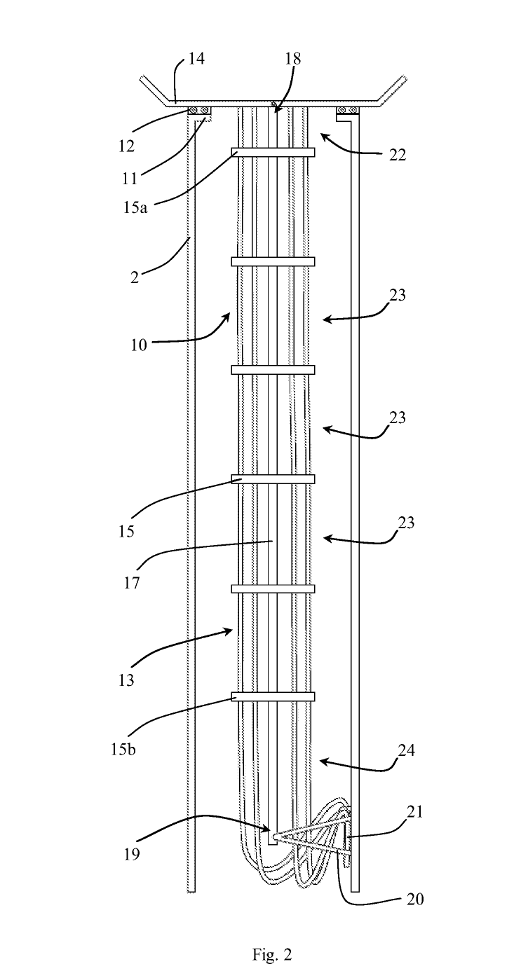

FIG. 2 shows a first exemplary embodiment of a cable twisting system 10 arranged inside the wind turbine tower 2. The wind turbine tower 2 comprises a top 11 in the form of a ring shaped top on which one or more yaw bearings 12 are arranged. The yaw bearing 12 is configured to rotate the nacelle 3 relative to the wind turbine tower 2. A separate circuit (not shown) configured to determine the yawing or twist of the nacelle 3 relative to its initial position may be coupled to the yaw bearing. The circuit may use a sprocket coupled to the yaw bearing to determine the twist or yaw of the nacelle 2.

One or more electrical cables 13 may be connected to the nacelle 3 and extend into the inside of the wind turbine tower 2 through the top 11, as shown in the figure. The electrical cables 13 may extend from the bottom 14 of the nacelle 3 and into the cable twisting system 10.

The cable twisting system 10 may comprise one or more cable spacing plates 15 which are distributed along the length of the cable twisting system 10. The cable spacing plates 15 may comprise one or more guiding means 16 configured to guide the electrical cables 13 from the top 11 in a direction towards the bottom (not shown) of the wind turbine tower 2. The cable spacing plates 15 may be coupled to at least one suspension element 17 in the form of a torsion rod or spring. The suspension element 17 may have a length corresponding to the length of the cable twisting system 10. The suspension element 17 may comprise a first end 18 and a second end 19 facing away from each other. The first end 18 may be configured to be mounted to the nacelle 3, e.g. via mounting means arranged at or near the bottom 14 of the nacelle 3. The second end 19 may be configured to be mounted to a support unit 20 arranged inside the wind turbine tower 2. The support unit 20 may be configured to align the suspension element 17 with a center axis of the nacelle 3, so that the first and second ends 18, 19 of the suspension element 17 form a common center axis. The center axis of the nacelle 3 may be defined by the yaw bearings 12.

At least one second guiding unit 21 may be arranged inside the wind turbine tower 2 between the cable twisting system 10 and the bottom of the wind turbine tower 2. The second guiding unit 21 may be configured to guide the cables 13 to the bottom of the wind turbine tower 2.

The cable spacing plates 15 may form a number of sections 22, 23, 24 arranged along the length of the cable twisting system 10. One or more of the sections 23 may be arranged, so that the distance between the cable spacing plates 15 forming these sections 23 are the same. The uppermost section 22 faces the bottom 14 of the nacelle 3 while the lowermost section 24 faces the support structure 20. The uppermost section 22 may be defined by the bottom 14 of the nacelle 3 and the uppermost cable spacing plate 15a. The lowermost section 24 may be defined by the lowermost cable spacing plate 15b and the support structure 20. The size or length of the uppermost and lowermost sections 22, 24 may differ from the size or length of the other sections 23.

The maximum angular rotation of the cable spacing plates 15 relative to each other may be determined by the maximum allowable twist of the nacelle 3, the selected torsion properties of the suspension element 17 and the number of sections 22, 23, 24.

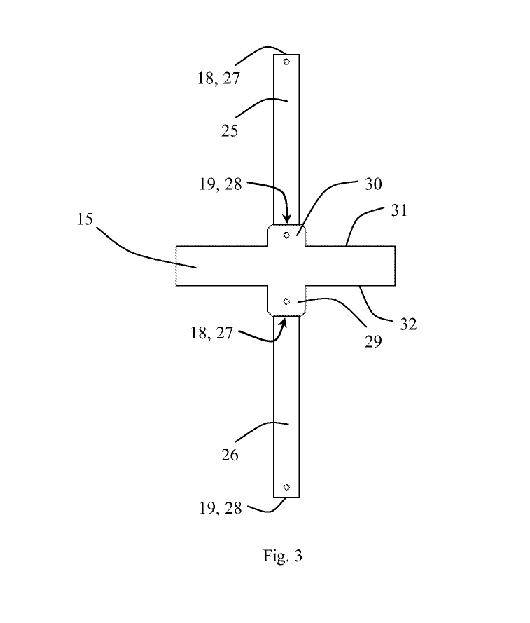

FIG. 3 shows a second exemplary embodiment of the suspension element 17 coupled to the cable spacing plates 15. In this embodiment, the suspension element 17 may be formed by a number of individual suspension elements 25, 26 in the form of torsion rods or springs aligned along the center axis of the nacelle 3. Each suspension element 25, 26 may have a length corresponding to the length of that section 22, 23, 24 in which it is arranged. The suspension elements 25, 26 each comprise a first end 27 facing the nacelle 3 and a second end 28 facing the bottom of the wind turbine tower 2. The first end 27 may be configured to be mounted to the bottom 14 of the nacelle 3 and/or to the mounting means 29 arranged on of the cable spacing plates 15. The second end 28 may be configured to be mounted to the support structure 20 and/or mounting means 30 arranged on an adjacent cable spacing plate 15. The mounting means 29, 30 may be arranged on a first side surface 31 facing the nacelle 3 and a second side surface 32 facing the bottom of the wind turbine tower 2 respectively. The mounting means 29, 30 may be shaped as a sleeve or bushing configured to receive and hold the ends 27, 28 of the suspension elements 25, 26. The mounting means 29, 30 and/or the ends 27, 28 of the suspension elements 25, 26 may comprise a through hole or recess in which fastening means may be placed in order to hold the ends 27, 28 in place. The fastening means may be bolts, pins, screws, or the like.

The suspension element 17 in the embodiment shown in FIG. 2 is formed by a single suspension element extending through the cable spacing plates 15 via a through hole in the plates 15. In that embodiment, the mounting means 29, 30 may be arranged on both side surfaces 31, 32 or only one of these where the fastening means is used to hold the cable spacing plate 15 in its position.

The number of sections 22, 23, 24 and thus the number of suspension elements 17, 25, 26 may be determined by the maximum allowable twist. The cable twisting system 10 may comprise seven sections and six cable spacing plates, as shown in FIG. 2. The cable spacing plates 15 may be coupled to a suspension element 17 extending through at least one of the plates 15, a suspension element 25, 26 coupled to at least one of the plates 15, or a combination thereof.

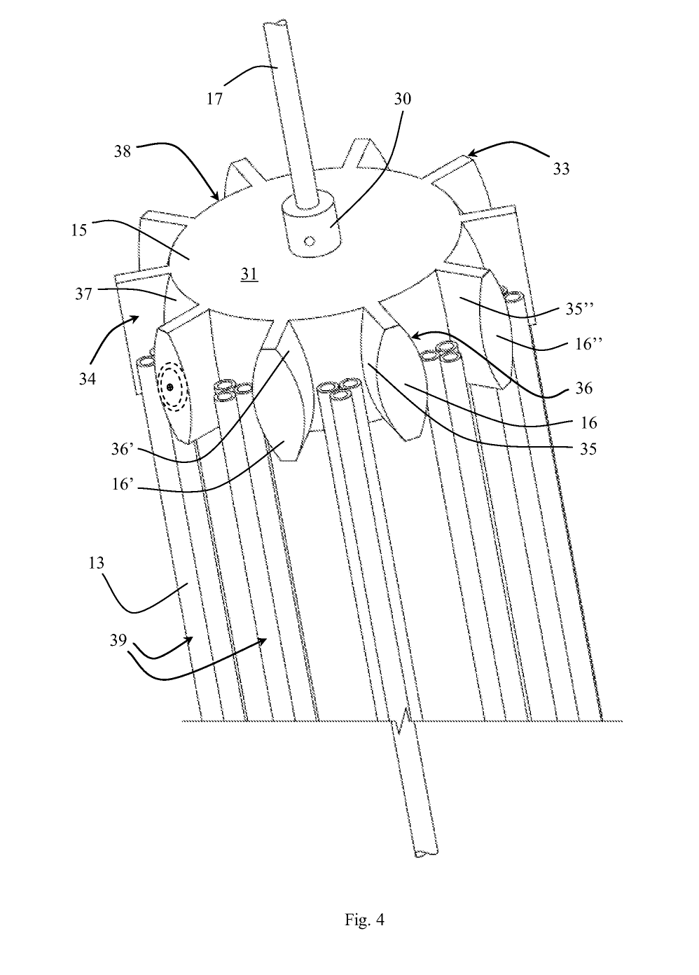

FIG. 4 shows an upper portion of a second exemplary embodiment of the cable twisting system 10 where only one cable spacing plate 15 is shown. The cable spacing plates 15 may be shaped as a disc having a circular outer periphery and a predetermined thickness. One or more guiding means 16 in the form of protrusions may be arranged in the outer periphery 33 and extend in a radial direction outwards from the center axis of the plate 15 which is defined by the suspension element 17, 25, 26. The protrusions 16 may form a number of recesses 34 or punches each of which is configured to receive and guide one or more of the cables 13 through the cable twisting system 10. Alternatively, the guiding means 16 may be wheels as indicated with the dotted lines in FIG. 4.

Each protrusion 16 may have a first side surface 35 and a second side surface 36, where the first side surface 35 faces another second side surface 36′ on an adjacent protrusion 16′, and the second side surface 36 faces another first side surface 35″ on an adjacent protrusion 16″. The side surfaces 35, 36 may have a convex shape where the curvature of the side surface curves towards the center of the recess 34. The bottom surface 37 of the recess 34 may be arranged along an inner periphery 38 of the cable spacing plate 15. The bottom surface 37 may have a convex shape where the curvature of the side surface curves towards the center of the recess 34. The cable spacing plate 15 may comprise one or more cut-outs (not shown) arranged between the inner periphery 38 and the center axis in order to save material and reduce weight.

The cable spacing plate 15 may comprise ten protrusions 16, as shown in FIG. 4, having a biconvex shape. The cables 13 may be arranged in a number of bundles 39 where each bundle 39 is arranged in a recess 34, as shown in FIG. 4. The size of each recess 34 may be configured so that the bundles 37 of cables 13 placed in the recesses 34 hang loosely inside the recesses 34.

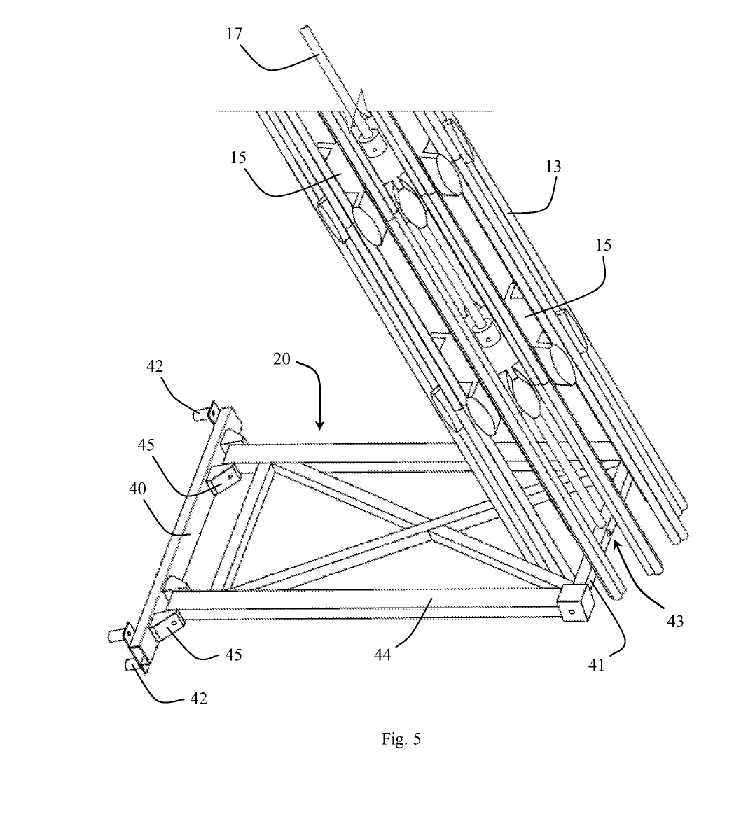

FIG. 5 shows a lower portion of the second cable twisting system shown in FIG. 4. The support structure 20 may comprise a first end 40 and a second end 41 facing away from each other. The first end 40 may comprise one or more mounting means 42 for mounting the support structure 20 to the inner surface of the wind turbine tower 2. The second end may comprise mounting means 43 for receiving and holding the lowermost second end 19, 28 of the suspension element 17, 25, 26 in place by the fastening means.

The second end 41 may be arranged at the free end of a support element 44 configured to align the mounting means 43 with the center axis of the nacelle 3 when the nacelle 3 is positioned in its initial position, i.e. when the cables 13 are untwisted. The support element 44 may at the other end be coupled to the first end 40 via one or pivoting joints 45 configured to pivot the support structure relative to the first end 40. This allows the second end 19, 22 of the lowermost suspension element 17, 25, 26 to be lifted upwards towards the nacelle 3 as the suspension element 17, 25, 26 is twisted.

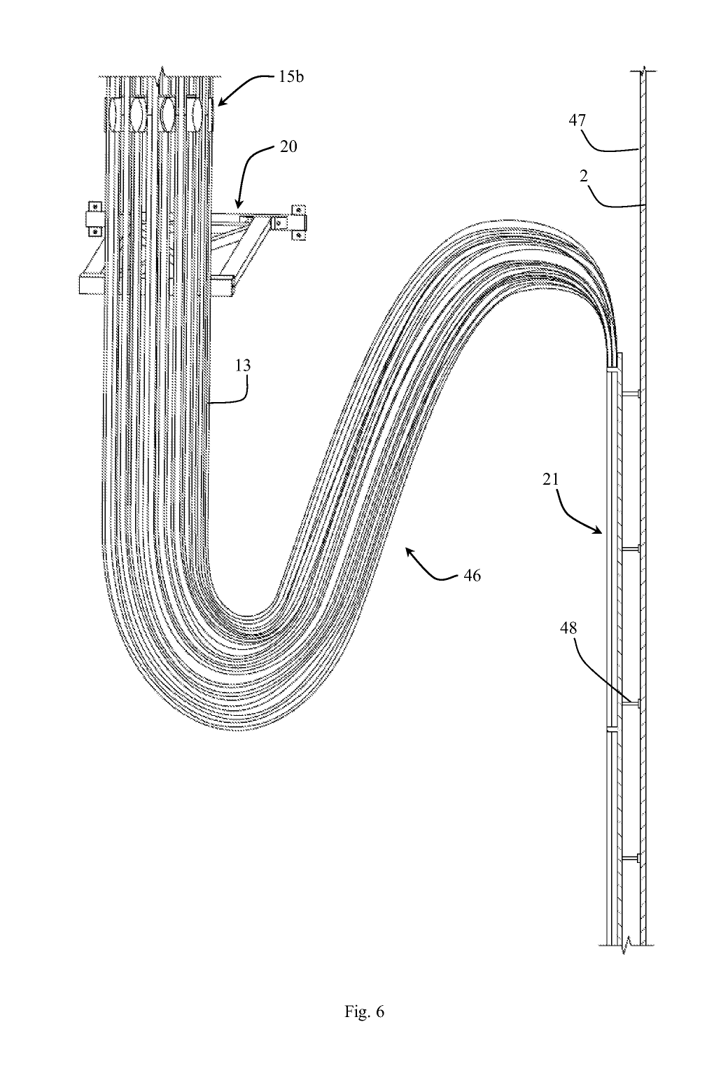

FIG. 6 shows an exemplary embodiment of a cable loop arrangement 46 connected to the cable twisting system 10 shown in FIG. 5. The cables 13 may be guided out of the cable twisting system 10 and into the second guiding unit 21 arranged between the cable twisting system 10 and the bottom of the wind turbine tower 2. The second guiding unit 21 may enable the cables 13 to form the cable loop arrangement 46 just below the cable twisting system 10. The cable loop arrangement 46 may be configured to compensate for the twisting and retracting of the cables 13 occurring in the cable twisting system 10. The cable loop arrangement may comprise an excess amount of cable 13 having a cable length which at least corresponds to the maximum retracting of the cables 13 relative the lowermost cable spacing plate 15b.

The second guiding unit 21 may be arranged along the inner surface 47 of the wind turbine tower 2. The second guiding unit 21 may be shaped as a cable channel or tray configured to guide the cables 13 to the bottom of the wind turbine tower 2. The second guiding unit 21 may have a length which more or less corresponds to the distance from the bottom of the cable twisting system 10 to the bottom of the wind turbine tower 2. The cable channel may be configured as a closed channel having two openings arranged in either end through which the cables 13 may extend. One or more clamping bands, wires or strips may be used to hold the cables in place in the second guiding means 21. The second guiding means 21 may comprise a number of mounting means 48 configured to be mounted to the inner surface 47 of the wind turbine tower 2.

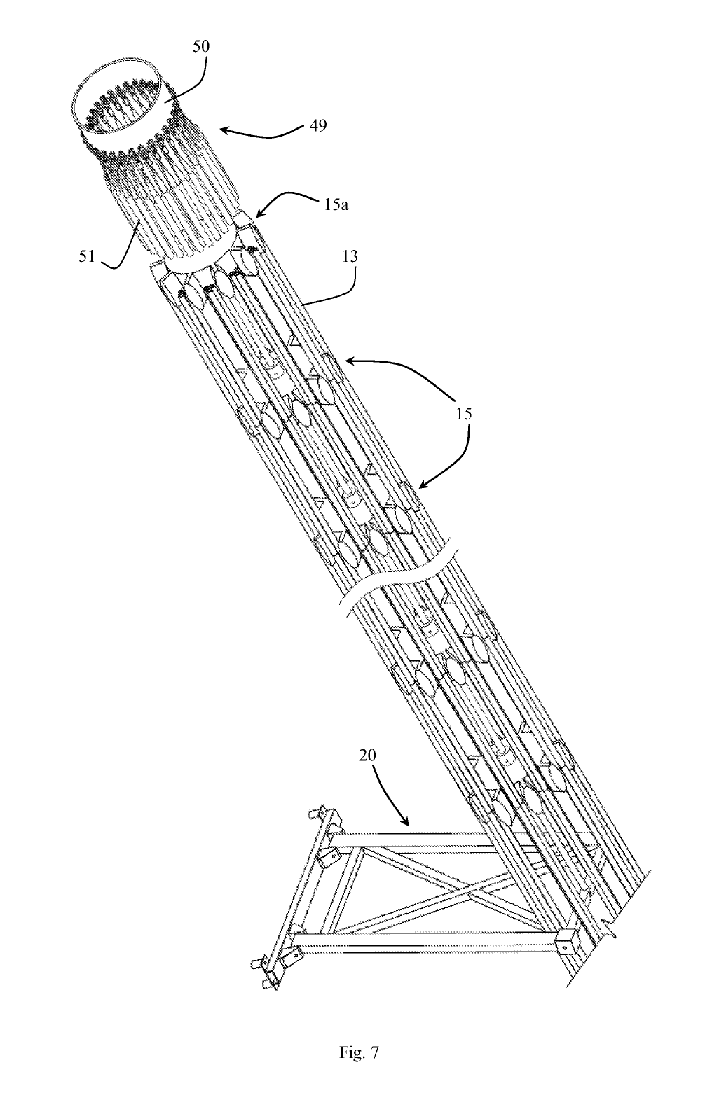

FIG. 7 shows the second cable twisting system 10 shown in FIGS. 4 and 5 with an exemplary embodiment of a top section. A third guiding unit 49 in the form of a cable stocking may be arranged between the bottom 14 of the nacelle 3 and the uppermost cable spacing plate 15a. The third guiding unit 49 may comprise an upper piece 50 in the form of a ring or cylindrical section which may be configured to be mounted to the bottom 14 of the nacelle 3. One or more guiding means 51 in the form of cable stockings may be mounted to the upper piece 49. The guiding means 51 may be shaped as a hollow elongated structure having an upper opening and a lower opening. The upper opening faces the nacelle 3 and may be configured to receive and guide the cables 13 into the third guiding unit 49. The lower opening faces the cable twisting system 10 and may guide the cables 13 into the uppermost cable spacing plate 15a.

The number of guiding means 51 may at least correspond to the number of cables 13 extending downwards from the bottom 14 of the nacelle 3. The length of the third guiding unit 49 may more or less correspond to the length of the uppermost section 22.

1. A wind turbine comprising:
a wind turbine tower having an inner side, a bottom, and a top;
a nacelle provided on top of the wind turbine tower, the nacelle arranged on one or more yaw bearings configured to rotate the nacelle relative to the wind turbine tower;
a rotor hub rotatably mounted to the nacelle and one or more wind turbine blades mounted to the rotor hub;
a cable twisting system arranged inside the wind turbine tower, the cable twisting system comprising one or more cable spacing plates coupled to at least one suspension element, the cable spacing plates being distributed along a length of the cable twisting system, the cable spacing plates having one or more guides configured to guide one or more electrical cables from the top of the wind turbine tower towards the bottom of the wind turbine tower, the electrical cables being connected to the nacelle and extending inside the wind turbine tower through the top thereof;
the suspension element having a first end facing the nacelle and a second end facing the bottom of the wind turbine tower, the wind turbine tower and suspension element having a common center axis; and
wherein the first end of the suspension element is configured to twist relative to the second end when torque is applied to the first end, and the first end is configured to return to its initial position when the torque is removed.

2. A wind turbine according to claim 1, wherein the one or more cable spacing plates divide the cable twisting system into two or more sections, such that the suspension element extends through at least one of the cable spacing plates which is coupled to the suspension element.

3. A wind turbine according to claim 1, wherein the one or more cable spacing plates divide the cable twisting system into two or more sections, such that at least one of the sections comprises another separate suspension element which is coupled to at least one cable spacing element.

4. A wind turbine according to claim 2, wherein the second end of the suspension element in a lowermost section relative to the nacelle is configured to be mounted to a support unit arranged inside the wind turbine tower.

5. A wind turbine according to claim 1, wherein the guides are protrusions formed on the cable spacing plate and extend in a radial direction outwards from a center axis of the plate, and a plurality of recesses being formed between the protrusions which are configured to receive at least one of the electrical cables.

6. A wind turbine according to claim 5, wherein each protrusion comprises a first side surface and a second side surface, the first side surface facing another second side surface on an adjacent protrusion, and the second side surface facing another first side surface on an adjacent protrusion, wherein at least one of the two side surfaces is convex.

7. A wind turbine according to claim 1, wherein the guides include wheels configured to rotate around a second center axis of said guides connected to the cable spacing plate and arranged relative to a center axis of the plate, wherein the wheels comprise at least one surface configured to receive and guide at least one of the cables.

8. A wind turbine according to claim 1, wherein the cable twisting system comprises a support unit arranged inside the wind turbine tower, one end of the support unit mounted to the inner side of the wind turbine tower and the other end of the support unit being mounted to the suspension element in a lowermost section relative to the nacelle.

9. A wind turbine according to claim 1, wherein a second guide is arranged inside the wind turbine tower between the cable twisting system and the bottom of the wind turbine tower, the second guiding unit being configured to guide the cables to the bottom of the wind turbine tower.

10. A wind turbine according to claim 9, wherein the electrical cables form a cable loop arrangement between the cable twisting system and the second guide.

11. A wind turbine according to claim 1, wherein a third guide is arranged between the nacelle and the cable twisting system and mounted to the nacelle, the third guide comprising one or more guiding means for guiding the cables from the nacelle to the cable twisting system.

12. A wind turbine according to claim 1, wherein the suspension element is a torsion element, the suspension element is configured to rotate the cable spacing plates relative to each other due to the torsion properties of the torsion element.

13. A wind turbine according to claim 12, wherein the suspension element has a Young modulus of at least 30 GPa.
